(19) United States
(12) Patent Application Publication
(10) Pub. No.: US 2021/0070316 A1
(43) Pub. Date: Mar. 11, 2021

(54) METHOD AND APPARATUS FOR VOICE CONTROLLED MANEUVERING IN AN ASSISTED DRIVING VEHICLE

(71) Applicant: GM GLOBAL TECHNOLOGY OPERATIONS LLC, Detroit, MI (US)

(72) Inventors: Robert A. Hrabak, Sterling Heights, MI (US); Paul R. Williams, Northville, MI (US)

(73) Assignee: GM GLOBAL TECHNOLOGY OPERATIONS LLC, Detroit, MI (US)

(21) Appl. No.: 16/564,263

(22) Filed: Sep. 9, 2019

(51) Int. Cl. B60W 50/10; B60K 35/00; G05D 1/00; G05D 1/02; B60W 30/18

(52) U.S. Cl. CPC B60W 50/10; B60K 35/00; G05D 1/0088; G05D 2201/0213; B60W 30/18; B60K 2370/148; B60K 2370/175; G05D 1/0246

(57) ABSTRACT

The present application relates to a method and apparatus including a microphone for receiving an utterance, a memory to store a map data, a processor operative to perform a voice recognition algorithm to recognize a navigational request in response to the utterance, to determine a location of a host vehicle, a micro destination in response to the navigational request and the map data, and a maneuver point between the location of the host vehicle and the micro destination and to generate a motion path between the location of the host vehicle, the maneuver point, and the micro destination, and a vehicle controller to control the host vehicle in response to the motion path.

### BACKGROUND

The present disclosure relates generally to programming motor vehicle control systems. More specifically, aspects of this disclosure relate to systems, methods and devices for providing a speech detection system for receiving vehicle operator utterances and controlling a vehicle in response to the received utterances for use by a vehicle control system.

The operation of modern vehicles is becoming more automated, i.e. able to provide driving control with less and less driver intervention. Vehicle automation has been categorized into numerical levels ranging from zero, corresponding to no automation with full human control, to five, corresponding to full automation with no human control. Various automated driver-assistance systems (ADAS), such as cruise control, adaptive cruise control, and parking assistance systems correspond to lower automation levels, while true “driverless” vehicles correspond to higher automation levels.

Frequently ADAS equipped vehicles operating at the lower automation levels are controlled without a vehicle created motion path, such as during adaptive cruise control operations. For example, operations wherein the vehicle system is maintaining an operation without an end to the operation being defined, such as driving on a highway, may be an example of a supervised automated driving state without a vehicle created motion path. Without a vehicle created motion path, before the vehicle executes another operation, such as a lane change or exiting a highway on an off ramp, the driver must typically resume vehicle control and execute the next operation or instruct the vehicle to perform the next operation. It would be desirable for an automated driving system be directed by the supervising driver in real time instead of having the driver resume control.

The above information disclosed in this background section is only for enhancement of understanding of the background of the invention and therefore it may contain information that does not form the prior art that is already known in this country to a person of ordinary skill in the art.

### SUMMARY

Disclosed herein are autonomous vehicle control system training systems and related control logic for provisioning autonomous vehicle control, methods for making and methods for operating such systems, and motor vehicles equipped with onboard control systems. By way of example, and not limitation, there is presented an automobile with onboard vehicle control learning and control systems.

In accordance with an aspect of the present invention, an apparatus including a microphone for receiving an utterance, a memory to store a map data, a processor operative to perform a voice recognition algorithm to recognize a navigational request in response to the utterance, to determine a location of a host vehicle, a micro destination in response to the navigational request and the map data, and a maneuver point between the location of the host vehicle and the micro destination and to generate a motion path between the location of the host vehicle, the maneuver point, and the micro destination, and a vehicle controller to control the host vehicle in response to the motion path.

In accordance with another aspect of the present invention wherein the processor is further operative to determine if the navigational request is a relative intent request.

In accordance with another aspect of the present invention wherein the processor is further operative to determine if the navigational request is an absolute intent request.

In accordance with another aspect of the present invention further including a user interface and wherein the processor is further operative to generate a user request for confirmation in response to the recognition of the navigational request and to receive a user confirmation via the microphone and wherein the motion path is coupled to the vehicle controller in response to the user confirmation.

In accordance with another aspect of the present invention where the location of the host vehicle is determined in response to a location data from a global positioning system.

In accordance with another aspect of the present invention wherein the processor is operative to generate an operator clarification request in response to a non-recognition of the utterance.

In accordance with another aspect of the present invention wherein the vehicle controller is further operative to perform an assisted driving algorithm.

In accordance with another aspect of the present invention wherein the navigational request is a vehicle maneuver request made during a host vehicle assisted driving operation.

In accordance with another aspect of the present invention, a method including receiving an utterance from a user indicative of a vehicle maneuver request, recognizing the utterance to identify the vehicle maneuver request, detecting a current vehicle location via a global positioning system, determining a maneuver intent of the vehicle maneuver request wherein the maneuver intent is at least one of an absolute maneuver intent and a relative maneuver intent, calculating a maneuver point and a micro destination in response to the vehicle maneuver request and the maneuver intent, generating a motion path between the current vehicle location, the maneuver point and the micro destination, and controlling the vehicle along the motion path to the micro destination.

In accordance with another aspect of the present invention including determining a maneuver direction in response to the vehicle maneuver request and the maneuver intent and wherein the maneuver point and micro destination are calculated in response to the maneuver direction

In accordance with another aspect of the present invention including performing an adaptive cruise control operation before controlling the vehicle along the motion path and after controlling the vehicle along the motion path.

In accordance with another aspect of the present invention including performing an advanced driver assistance system operation before controlling the vehicle along the motion path and after controlling the vehicle along the motion path.

In accordance with another aspect of the present invention wherein the micro destination is calculated in response to a map data, the vehicle maneuver request and the maneuver intent.

In accordance with another aspect of the present invention including requesting a confirmation of the vehicle maneuver request, to receive the confirmation of the vehicle maneuver request and to control the vehicle along the motion path in response to the confirmation of the vehicle maneuver request.

In accordance with another aspect of the present invention including assuming a generic maneuver intent in response to not determining a maneuver intent and confirming the generic maneuver intent to an operator.

In accordance with another aspect of the present invention an apparatus for controlling a vehicle including a vehicle controller for performing an assisted driving operation and to perform a vehicle maneuver in response to a motion path, a user interface operative to receive a vehicle maneuver request from a vehicle operator, a global positioning system sensor for detecting a location of the vehicle, a memory for storing a map data of an area proximate to the location of the vehicle, a processor for determining an intent of the vehicle maneuver request, for calculating a micro destination in response to the intent of the vehicle maneuver request, the map data, the location of the vehicle, the processor being further operative to determine a maneuver point between the micro destination and the location of the vehicle and to calculate the motion path between the location of the vehicle, the maneuver point and the micro destination and to couple the motion path to the vehicle controller.

In accordance with another aspect of the present invention including a camera for detecting an image of a field of view and wherein the assisted driving operation is performed in response to the image.

In accordance with another aspect of the present invention wherein the vehicle controller is operative to perform the assisted driving operation in response to an operator request received via a user interface.

In accordance with another aspect of the present invention wherein the intent of the vehicle maneuver request is a relative intent request and the vehicle maneuver is performed in response to the location of the vehicle.

In accordance with another aspect of the present invention wherein the intent of the vehicle maneuver request is an absolute intent request and the vehicle maneuver is performed in response to the map data of the area proximate to the location of the vehicle.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 shows an operating environment for voice-controlled maneuvering in an assisted driving vehicle according to an exemplary embodiment.

FIG. 2 shows a block diagram illustrating a system for voice-controlled maneuvering in an assisted driving vehicle according to an exemplary embodiment.

FIG. 3 shows a flow chart illustrating a method for voice-controlled maneuvering in an assisted driving vehicle according to another exemplary embodiment.

FIG. 4 shows a block diagram illustrating an exemplary implementation of a system for voice-controlled maneuvering in an assisted driving vehicle according to another exemplary embodiment.

FIG. 5 shows a flow chart illustrating a method for voice-controlled maneuvering in an assisted driving vehicle according to another exemplary embodiment.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

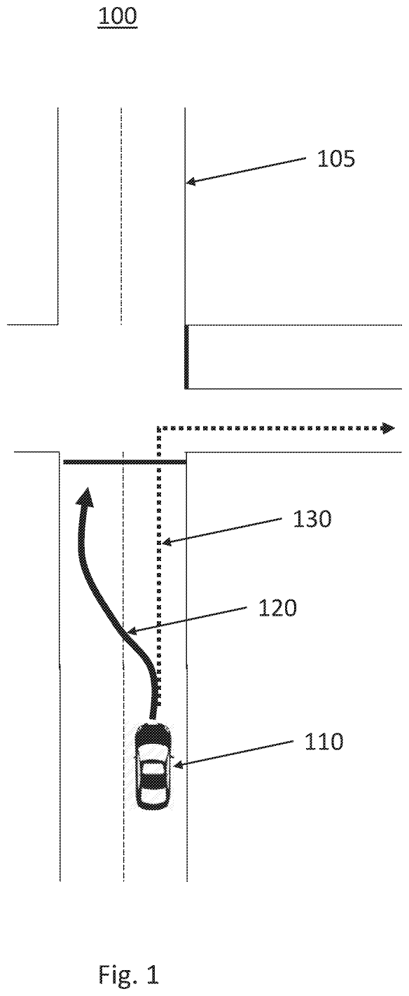

FIG. 1 schematically illustrates an operating environment 100 for voice-controlled maneuvering in an assisted driving vehicle 110. In this exemplary embodiment of the present disclosure, the vehicle is traveling along a road lane demarcated by lane markers 105. The present disclosure teaches a method and apparatus for triggering a vehicle operation in a vehicle that is in a supervised automated driving state, such as adaptive cruise control, to complete a maneuver based on the descriptive utterance of the supervisor, as understood and confirmed by speech recognition software, as an alternative to a full navigational route fed to the automated vehicle.

The exemplary system and are operative to enable a vehicle operator to dynamically create a driven route for the vehicle 110 to maneuver/navigate. The exemplary method is first operative to identify a user's intended driving maneuver through location, voice recognition and dialogue, and determination of micro-destination. The method then determine the success criteria of the completed maneuver through generation of micro-destination as a navigational waypoint based on user's maneuver description and/or instruction.

The exemplary vehicle supervised active guidance system may be used to construct the experience of the maneuver on demand operation where a supervising operator can direct an ADAS equipped vehicle to maneuver a route on ad-hoc basis as requested by the supervising operator. For example, a triggered vehicle operation may include a maneuver with an absolute intent 130, such as “turn left on Park avenue” or a maneuver with a relative intent 120, such as “move one lane to the left” or “take the next right.” The disclosed system is operative to recognize the driver utterance as an intended vehicle maneuver, whether absolute or relative. If the utterance intent is a destination intent, such as “go home” the exemplary method may be operative to determine a destination for the vehicle and assume autonomous control of the vehicle to maneuver the vehicle to the destination. If the intent is an absolute intent maneuver or a relative intent maneuver, the method may then be operative to create a vehicle motion path by generating a route waypoint to complete the desired maneuver relative to a map location or the vehicle location.

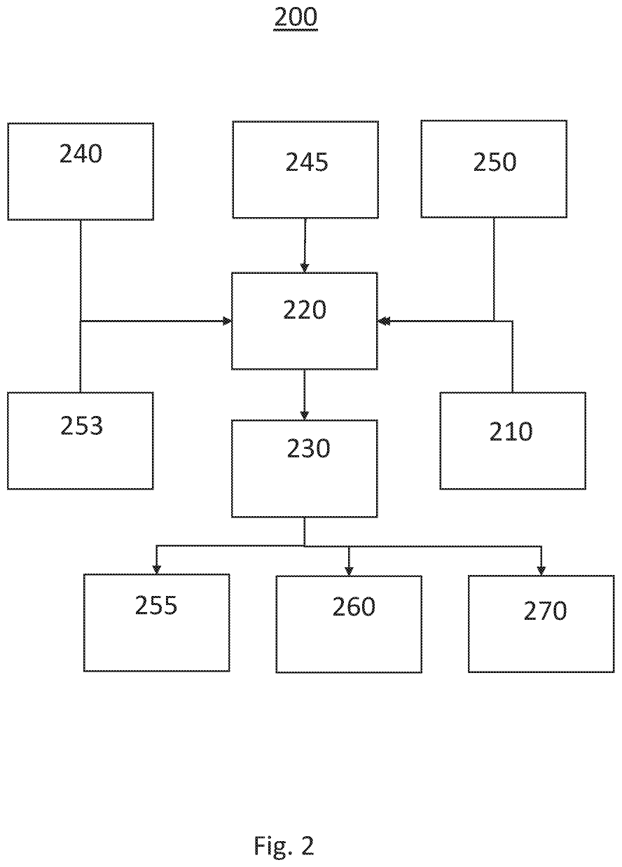

Turning now to FIG. 2, a block diagram illustrating an exemplary implementation of a system 200 for voice-controlled maneuvering in an assisted driving vehicle is shown. The system 200 includes a processor 220, a microphone 210, a camera 240 and a GPS sensor 245. The processor 220 may receive information such as map data from a memory 250 or the like, and user input via a user interface 253.

The camera 240 may be a low fidelity camera with a forward field of view (FOV). The camera 240 may be mounted inside the vehicle behind the rear view mirror or may be mounted on the front fascia of the vehicle. The camera may be used to detect obstacles, lane markers, road surface edges, and other roadway markings during ADAS operation. In addition, an image of the FOV captured by the camera may be used combined with data from other sensors to generate a three-dimensional depth map of the FOV in order to determine safe maneuver point locations while performing maneuvers based on the descriptive utterance of the supervisor.

The GPS sensor 245 receives a plurality of time stamped satellite signals including the location data of a transmitting satellite. The GPS then uses this information to determine a precise location of the GPS sensor 245. The processor 220 may be operative to receive the location data from the GPS sensor 245 and store this location data to the memory 250. The memory 250 may be operative to store map data for use by the processor 220.

The user interface 253 may be a user input device, such as a display screen, light emitting diode, audible alarm or haptic seat located in the vehicle cabin and accessible to the driver. Alternatively, the user interface 235 may be a program running on an electronic device, such as a mobile phone, and in communication with the vehicle, such as via a wireless network. The user interface 235 is operative to collect instructions from a vehicle operator such as initiation and selection of an ADAS function, desired following distance for adaptive cruise operations, selection of vehicle motion profiles for assisted driving, etc. In response to a selection by the vehicle operator, the user interface 235 may be operative to couple a control signal or the like to the processor 240 for activation of the ADAS function. The user interface may be operative to receive a user input regarding desired destination for generating a navigational route. The user interface maybe be operative to display the navigational route, upcoming portions of the navigational route, and upcoming turns and other vehicle maneuvers for the navigational route. Further, the user interface may be operative to provide a user prompt or warning indicative of an upcoming high-risk area, rerouting of a navigational route, presentation of an alternative route avoiding the high-risk area, and/or potential disengagement event of the ADAS and/or a request for the user to take over control of the vehicle. In addition, the microphone 210 may be operative to receive a vehicle operator voice command as part of a voice recognition operation. In this exemplary embodiment, the voice command, or utterance, by be used to initiate a voice-controlled maneuver in an ADAS equipped vehicle.

The processor 220 may be operative to engage and control the ADAS in response to an initiation of the ADAS from a user via the user interface 253. In an ADAS operation, the processor 220 may be operative to generate a desired path in response to a user input or the like wherein the desired path may include lane centering, curve following, lane changes, etc. This desired path information may be determined in response to the vehicle speed, the yaw angle and the lateral position of the vehicle within the lane. Once the desired path is determined, a control signal is generated by the processor 220 indicative of the desired path and is coupled to the vehicle controller 230. The vehicle controller 230 is operative to receive the control signal and to generate an individual steering control signal to couple to the steering controller 270, a braking control signal to couple to the brake controller 260 and a throttle control signal to couple to the throttle controller 255 in order to execute the desired path.

According to an exemplary embodiment, the processor 220 is operative to receive a vehicle operator utterance via the microphone 210 and to perform a voice recognition operation on the utterance to determine if the utterance has a navigational intent. If the utterance has a navigational intent, the processor 220 is then operative to determine if the navigational utterance has a destination, relative or absolute maneuver intent. If the navigational utterance has a relative or absolute maneuver intent, the processor 220 is then operative to determine a direction of the navigational request and a probable maneuver point in response to the direction. The processor is then operative to eliminate invalid or multiple maneuver points and to identify a micro-destination for the maneuver. The processor 220 then generates a motion path between the current vehicle location, the maneuver point, and the micro destination. The processor 220 is then operative to couple the motion path, or a control signal representative of the motion path, to the vehicle controller 230 to execute the requested maneuver. The processor 220 may be further operative to request a clarification from the operator if any one of the previous steps, such as an unrecognized utterance. The clarification requested may be present to the operative via the user interface or an audio alert played via a speaker or the like. In addition, once the intended maneuver is recognized, a confirmation of the intended maneuver maybe requested before the motion path or control signal is coupled to the vehicle controller 230.

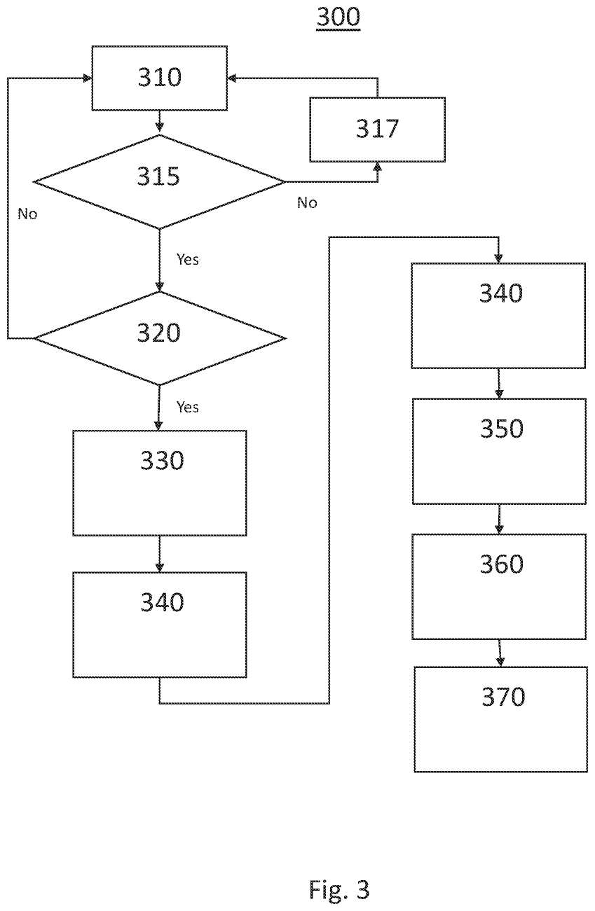

Turning now to FIG. 3, a flow chart illustrating an exemplary implementation of a method 300 for voice controlled maneuvering in an assisted driving vehicle is shown. The method is first operative to receive 310 a user utterance via a microphone. The microphone may be located within a vehicle cabin or may be a component of a connected device, such as a mobile phone. A voice recognition operation is then performed 315 on the utterance. If the utterance is not recognized by the voice recognition operation, the method is then operative to request 317 for the driver to repeat the utterance. The method is then operative to return to receiving 310 a subsequent utterance.

If the utterance is recognized by the by the voice recognition operation, the utterance is classified by domain. If the utterance is classified as a navigational utterance 320, the method is next operative to determine 330 the utterance intent type. If the utterance is not of a navigational intent, the utterance is then coupled to a non-navigational input process and the method is operative to return to receiving 310 a subsequent utterance.

In response to an utterance, intent of a navigational domain control requested may be classified 320 as an intended destination intent, absolute maneuver intent, relative maneuver intent, or generic maneuver intent. If the utterance intent has an intended destination intent, such as “go home,” a destination entry route computation process may be performed to generator a maneuver vector which is then coupled to the automated driving system. If the utterance intent is determined to be an absolute maneuver intent, such as “turn on Park Ave.,” or a relative maneuver intent, such as “take the next left,” the method is next operative to determine a probable intent direction 340. If the utterance intent cannot be determined, a generic maneuver intent is assumed, such as “turn here.” The method is then operative to determine 340 the generic maneuver probable direction.

In response to the utterance intent, the method is next operative to determine 340 a probable intent direction. If there is an uncertain intent direction, If the method is uncertain of the intent direction, the method may request a clarification of direction from the operator. Once the direction is clarified, the method is operative to determine 340 a micro destination in response to the direction. The micro destination is a location near the completion of the requested maneuver which may be determined in response to vehicle speed, location, traffic patterns, proximate vehicles, and the proximate roadways. The micro destination is determined in response to the utterance intent.

A maneuver point is then determined 350 in response to the micro destination. In determining a maneuver point, the method may operative to eliminate invalid maneuver points using clarified micro destination. In addition, if the method determines that there are multiple possible maneuver points, the method may request clarification from the operator to identify a requested maneuver point. The method is then operative to calculate 360 a motion path to the requested maneuver point and the micro destination. The motion path is a calculated path that will be taken by the vehicle in order to compete the requested maneuver. Finally, the motion path is coupled to the vehicle control and used by that ADAS to control. In an alternate embodiment, the maneuver point and the micro destination may be the same point. Alternatively, the motion path may include multiple maneuver points.

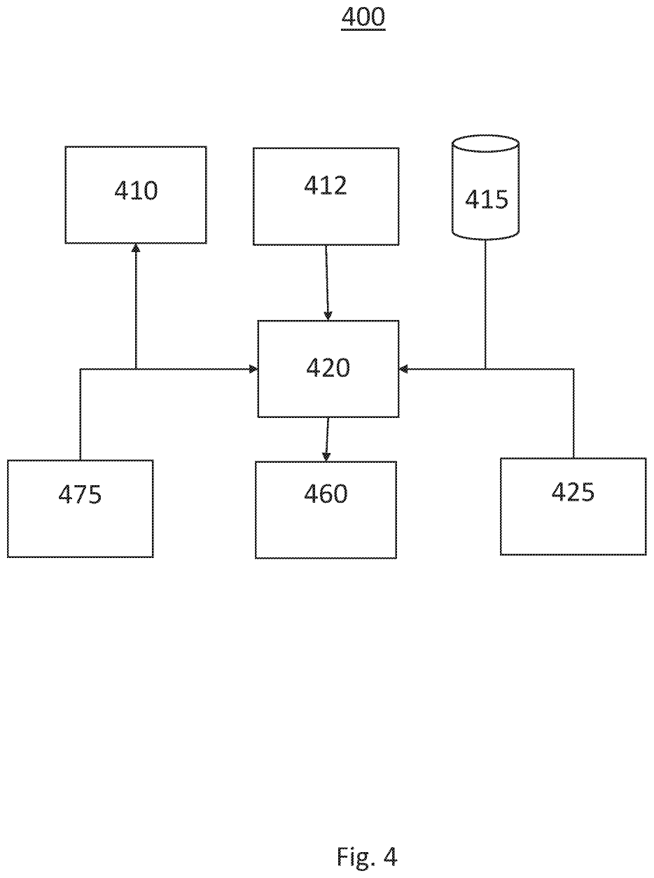

Turning now to FIG. 4, a block diagram illustrating an exemplary implementation of a system 400 for voice-controlled maneuvering in an assisted driving vehicle is shown. The system 400 may include a microphone 410, a camera 475, a global positioning system sensor 412 a memory 415, a processor 420, a vehicle controller 460, and a user interface 425. In this exemplary system, the microphone 410 is located in a vehicle cabin and is used to receive an utterance from a vehicle occupant and to convert the utterance in to an electrical representation of the utterance and for coupling the electrical representation of the utterance to the processor.

The memory 415 is operative to store a map data wherein the map data may include roadway locations, traffic indicator location, obstacle locations, topographical and other geographical location information of the area around the current location of the vehicle. The map data may be received via a wireless network, such as a cellular data network, and may be updated periodically or when a vehicle changes location.

The camera 475 may be a forward-facing camera located behind the vehicle windshield and may be operative to detect an image of a field of view. The image and subsequent images, as well as other sensor data, may be used to generate a three-dimensional map of the field of view and/or a three-dimensional depth map. The assisted driving operation is performed in response to the image and/or the three-dimensional map.

The processor 420 may be operative to a voice recognition algorithm to recognize a navigational request in response to the received electronic representation of the operator utterance, to determine a location of a host vehicle in response to a signal from the global positioning system 412. The processor 420 is further operative to determine a micro destination in response to the navigational request and the map data and to determine a maneuver point between the location of the host vehicle and the micro destination. The processor 420 is then operative to generate a motion path between the location of the host vehicle, the maneuver point, and the micro destination. The processor 420 may be further operative to determine if the navigational request is a relative intent request or an absolute intent request. If the intent of the navigational request is a relative intent request, such as “turn left at the next street,” the subsequent vehicle maneuver is performed in response to the location of the vehicle. If the intent of the vehicle maneuver request is an absolute intent, such as “turn left on Park Street,” the subsequent vehicle maneuver is performed in response to the map data of the area proximate to the location of the vehicle. In addition, the processor 420 may be operative to generate an operator clarification request in response to a non-recognition of the utterance.

In an alternative embodiment, the processor 420 is operative for determining an intent of the vehicle maneuver request, for calculating a micro destination in response to the intent of the vehicle maneuver request, the map data and the location of the vehicle. The processor 420 is operative to determine a maneuver point between the micro destination and the location of the vehicle and to calculate the motion path between the location of the vehicle, the maneuver point and the micro destination and to couple the motion path to a vehicle controller 460.

The exemplary system 400 further includes a vehicle controller 460 to control the host vehicle in response to the motion path. The vehicle controller 460 may be further operative to perform an assisted driving algorithm wherein the navigational request is a vehicle maneuver request made during a host vehicle assisted driving operation. The vehicle controller 460 may be operative to perform the assisted driving operation in response to an operator request received via a user interface. The vehicle controller 460 is operative to perform the vehicle maneuver in response to a motion path received from the processor 420.

The user interface 425 may further be operative to receive a vehicle maneuver request from a vehicle operator. The processor 420 may then generate a user request for confirmation in response to the recognition of the navigational request and to receive a user confirmation via the microphone 410. The motion path is then coupled to the vehicle controller 460 in response to the user confirmation

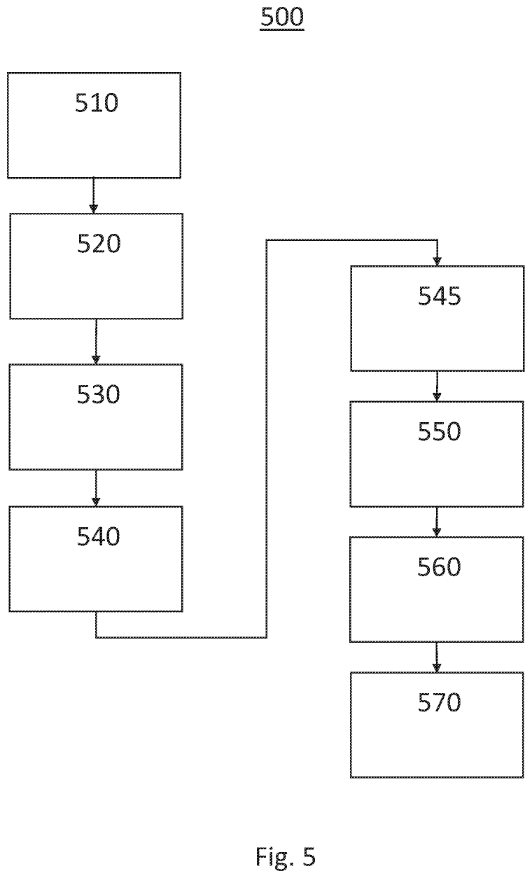

Turning now to FIG. 5, a flow chart illustrating an exemplary implementation of a system 500 for voice-controlled maneuvering in an assisted driving vehicle is shown. In this exemplary embodiment the method 500 is first operative to receive 510 an utterance from a vehicle operator indicative of a vehicle maneuver request. The method is next operative to recognize 520 the utterance to identify the vehicle maneuver request. The method then detects 530 a current vehicle location via a global positioning system.

The method is next operative for determining 540 a maneuver intent of the vehicle maneuver request wherein the maneuver intent is at least one of an absolute maneuver intent and a relative maneuver intent. Additionally, a generic maneuver intent may be assumed in response to not determining a maneuver intent and confirming the generic maneuver intent to a vehicle operator. The method is next operative for determining 545 a maneuver direction in response to the vehicle maneuver request and the maneuver intent and wherein the maneuver point and micro destination are calculated in response to the maneuver direction

The method is next operative for calculating 550 a maneuver point and a micro destination in response to the vehicle maneuver request and the maneuver intent. The micro destination may be calculated in response to a map data, the vehicle maneuver request and the maneuver intent. generating 560 a motion path between the current vehicle location, the maneuver point and the micro destination. The method is then operative for controlling 570 the vehicle along the motion path to the micro destination.

In an additional embodiment, the method may further be operative to perform an advanced driver assistance system operation, such as an adaptive cruise control operation before controlling the vehicle along the motion path and after controlling the vehicle along the motion path. The method may further be operative to request a confirmation of the vehicle maneuver request, to receive the confirmation of the vehicle maneuver request and to control the vehicle along the motion path in response to the confirmation of the vehicle maneuver request.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a microphone for receiving an utterance;
a memory to store a map data;
a processor operative to perform a voice recognition algorithm to recognize a navigational request in response to the utterance, to determine a location of a host vehicle, a micro destination in response to the navigational request and the map data, and a maneuver point between the location of the host vehicle and the micro destination and to generate a motion path between the location of the host vehicle, the maneuver point, and the micro destination; and
a vehicle controller to control the host vehicle in response to the motion path.

2. The apparatus of claim 1 wherein the processor is further operative to determine if the navigational request is a relative intent request.

3. The apparatus of claim 1 wherein the processor is further operative to determine if the navigational request is an absolute intent request.

4. The apparatus of claim 1 further including a user interface and wherein the processor is further operative to generate a user request for confirmation in response to the recognition of the navigational request and to receive a user confirmation via the microphone and wherein the motion path is coupled to the vehicle controller in response to the user confirmation.

5. The apparatus of claim 1 where the location of the host vehicle is determined in response to a location data from a global positioning system.

6. The apparatus of claim 1 wherein the processor is operative to generate an operator clarification request in response to a non-recognition of the utterance.

7. The apparatus of claim 1 wherein the vehicle controller is further operative to perform an assisted driving algorithm.

8. The apparatus of claim 1 wherein the navigational request is a vehicle maneuver request made during a host vehicle assisted driving operation.

9. A method comprising:
receiving an utterance from a user indicative of a vehicle maneuver request;
recognizing the utterance to identify the vehicle maneuver request;
detecting a current vehicle location via a global positioning system;
determining a maneuver intent of the vehicle maneuver request wherein the maneuver intent is at least one of an absolute maneuver intent and a relative maneuver intent;
calculating a maneuver point and a micro destination in response to the vehicle maneuver request and the maneuver intent;
generating a motion path between the current vehicle location, the maneuver point and the micro destination; and
controlling the vehicle along the motion path to the micro destination.

10. The method of claim 9 further including determining a maneuver direction in response to the vehicle maneuver request and the maneuver intent and wherein the maneuver point and micro destination are calculated in response to the maneuver direction

11. The method of claim 9 further including performing an adaptive cruise control operation before controlling the vehicle along the motion path and after controlling the vehicle along the motion path.

12. The method of claim 9 further including performing an advanced driver assistance system operation before controlling the vehicle along the motion path and after controlling the vehicle along the motion path.

13. The method of claim 9 wherein the micro destination is calculated in response to a map data, the vehicle maneuver request and the maneuver intent.

14. The method of claim 9 further operative to request a confirmation of the vehicle maneuver request, to receive the confirmation of the vehicle maneuver request and to control the vehicle along the motion path in response to the confirmation of the vehicle maneuver request.

15. The method of claim 9 further including assuming a generic maneuver intent in response to not determining a maneuver intent and confirming the generic maneuver intent to the user.

16. An apparatus for controlling a vehicle comprising:
a vehicle controller for performing an assisted driving operation and to perform a vehicle maneuver in response to a motion path;
a user interface operative to receive a vehicle maneuver request from a user;
a global positioning system sensor for detecting a location of the vehicle;
a memory for storing a map data of an area proximate to the location of the vehicle; and
a processor for determining an intent of the vehicle maneuver request, for calculating a micro destination in response to the intent of the vehicle maneuver request, the map data, the location of the vehicle, the processor being further operative to determine a maneuver point between the micro destination and the location of the vehicle and to calculate the motion path between the location of the vehicle, the maneuver point and the micro destination and to couple the motion path to the vehicle controller.

17. The apparatus for controlling a vehicle of claim 16 further including a camera for detecting an image of a field of view and wherein the assisted driving operation is performed in response to the image.

18. The apparatus for controlling a vehicle of claim 16 wherein the vehicle controller is operative to perform the assisted driving operation in response to a user request received via a user interface.

19. The apparatus for controlling a vehicle of claim 16 wherein the intent of the vehicle maneuver request is a relative intent request and the vehicle maneuver is performed in response to the location of the vehicle.

20. The apparatus for controlling a vehicle of claim 16 wherein the intent of the vehicle maneuver request is an absolute intent request and the vehicle maneuver is performed in response to the map data of the area proximate to the location of the vehicle.
